(19) United States
(12) Patent Application Publication
(10) Pub. No.: US 2011/0180398 A1
(43) Pub. Date: Jul. 28, 2011

(54) WATER ELECTROLYSIS APPARATUS

(75) Inventors: Koji NAKAZAWA, Utsunomiya-shi (JP); Kenji TARUYA, Utsunomiya-shi (JP); Eiji HARYU, Utsunomiya-shi (JP); Masanori OKABE, Nerima-ku (JP); Nobuyuki KAWASAKI, Shioya-gun (JP)

(73) Assignee: HONDA MOTOR CO., LTD., Tokyo (JP)

(21) Appl. No.: 13/011,369

(22) Filed: Jan. 21, 2011

(30) Foreign Application Priority Data
Jan. 25, 2010 (JP) 2010-013022

(51) Int. Cl. C25B 9/18; C02F 1/461

(52) U.S. Cl. 204/258; 204/253

(57) ABSTRACT

Each unit cell of a water electrolysis apparatus includes a pair of an anode separator and a cathode separator and a membrane electrode assembly interposed between the pair of separators. The anode separator has a first seal groove extending annularly around an anode current collector, a first seal member being disposed in the first seal groove. The cathode separator has a second seal groove extending annularly around a cathode current collector, a second seal member being disposed in the second seal groove. The first seal groove and the second seal groove are located across the solid polymer electrolyte membrane from each other respectively at different positions with respect to a stacking direction of the separators.

### CROSS-REFERENCE TO RELATED APPLICATION

This application is based upon and claims the benefit of priority from Japanese Patent Application No. 2010-013022 filed on Jan. 25, 2010, of which the contents are incorporated herein by reference.

### BACKGROUND OF THE INVENTION

1. Field of the Invention

The present invention relates to a water electrolysis apparatus including an electrolyte membrane, a pair of current collectors disposed on the respective opposite sides of the electrolyte membrane, and a pair of separators stacked on the current collectors, a circumferential edge portion of the electrolyte membrane being sandwiched between the separators.

2. Description of the Related Art

Solid polymer electrolyte fuel cells generate DC electric energy when anodes thereof are supplied with a fuel gas, i.e., a gas mainly composed of hydrogen, e.g., a hydrogen gas, and cathodes thereof are supplied with an oxygen-containing gas, a gas mainly composed of oxygen, e.g., air.

Generally, water electrolysis apparatus are used to generate a hydrogen gas for use as a fuel gas for such solid polymer electrolyte fuel cells. The water electrolysis apparatus employ a solid polymer electrolyte membrane (ion exchange membrane) for decomposing water to generate hydrogen (and oxygen). Electrode catalyst layers are disposed on the respective sides of the solid polymer electrolyte membrane, making up a membrane electrode assembly. Current collectors are disposed on the respective opposite sides of the membrane electrode assembly, making up a unit. The unit is essentially similar in structure to the fuel cells described above.

A plurality of such units are stacked, and a voltage is applied across the stack while water is supplied to the current collectors on the anode side. On the anodes of the membrane electrode assemblies, the water is decomposed to produce hydrogen ions (protons). The hydrogen ions move through the solid polymer electrolyte membranes to the cathodes, where the hydrogen ions combine with electrons to generate hydrogen. On the anodes, oxygen generated together with hydrogen is discharged with excess water from the units.

Such a water electrolysis apparatus generates hydrogen under a high pressure of several tens MPa. There is known a hydrogen supply apparatus as disclosed in Japanese Laid-Open Patent Publication No. 2004-002914, for example. As shown in FIG. 8 of the accompanying drawings, the disclosed hydrogen supply apparatus includes a number of unit cells each comprising an assembly which has an anode current collector 2, a cathode current collector 3, and an electrode assembly membrane 1 disposed between the collectors 2 and 3, and a pair of bipolar plates 4 sandwiching the assembly therebetween.

A flow field 5a for supplying water therethrough is defined between one of the bipolar plates 4 and the anode current collector 2, and a flow field 5b for passing generated hydrogen therethrough is defined between the other bipolar plate 4 and the cathode current collector 3. Each of the bipolar plates 4 has first seal grooves 7a, 7b defined in a peripheral edge portion thereof and accommodating first o-rings 6a respectively therein and second seal grooves 7c, 7d defined in a peripheral edge portion thereof and accommodating second o-rings 6b respectively therein.

In the above Japanese Laid-Open Patent Publication No. 2004-002914, the first seal grooves 7a, 7b face each other across the electrode assembly membrane 1, and similarly the second seal grooves 7c, 7d face each other across the electrode assembly membrane 1. Accordingly, the electrode assembly membrane 1 is sandwiched between the pair of first o-rings 6a, while the electrode assembly membrane 1 is sandwiched between the pair of second o-rings 6b. Thus, it is difficult to hold the electrode assembly membrane 1 flatwise.

Further, the flow field 5b serves as a high-pressure hydrogen generating chamber for generating high-pressure hydrogen. The second seal groove 7d, which is held in fluid communication with the flow field 5b, is filled with the high-pressure hydrogen, developing a high pressure therein. Thus, the electrode assembly membrane 1 is pressed toward the flow field 5a and the second seal groove 7c, and as a result, the electrode assembly membrane 1 is liable to be damaged particularly at a position corresponding to an edge portion of the bipolar plate 4 in which the second seal groove 7c is formed.

### SUMMARY OF THE INVENTION

It is an object of the present invention to provide a water electrolysis apparatus which is capable of preventing an electrolyte membrane from being damaged as far as possible, with a simple structure.

The present invention relates to a water electrolysis apparatus comprising an electrolyte membrane, a pair of current collectors disposed respectively on opposite sides of the electrolyte membrane, and a pair of separators stacked respectively on the current collectors, a circumferential edge portion of the electrolyte membrane being sandwiched between the separators.

In an aspect of the present invention, one of the separators has a first seal section extending annularly around one of the current collectors, a first seal member being disposed in the first seal section, the other of the separators has a second seal section extending annularly around the other of the current collectors, a second seal member being disposed in the second seal section, and the first seal section and the second seal section are located across the electrolyte membrane from each other, respectively at different positions with respect to a stacking direction of the separators.

In another aspect of the present invention, the water electrolysis apparatus further has a hydrogen passage through which hydrogen produced through electrolysis of water flows in a stacking direction of the separators, the hydrogen passage extending through the electrolyte membrane and the pair of the separators, one of the separators has a first seal section extending annularly around the hydrogen passage, a first seal member being disposed in the first seal section, the other of the separators has a second seal section extending annularly around the hydrogen passage, a second seal member being disposed in the second seal section, and the first seal section and the second seal section are located across the electrolyte membrane from each other, respectively at different positions with respect to the stacking direction of the separators.

According to the present invention, the first seal section and the second seal section extending annularly around the current collectors or the hydrogen passage are located across the solid polymer electrolyte membrane from each other, respectively at different positions with respect to the stacking direction of the separators. Thus, the first seal member disposed in the first seal section faces a surface of the separator, and also the second seal member disposed in the second seal section faces a surface of the separator.

Thus, since the electrolyte membrane is supported between the first seal member and the surface of the separator and between the second seal member and the surface of the separator, the electrolyte membrane can be held flatwise reliably. As a result, holding performance of the electrolyte membrane can be improved, and the electrolyte membrane can be prevented from being damaged as far as possible.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view of a water electrolysis apparatus according to a first embodiment of the present invention;

FIG. 2 is a side elevational view, partly in cross section, of the water electrolysis apparatus shown in FIG. 1;

FIG. 3 is an exploded perspective view of a unit cell of the water electrolysis apparatus;

FIG. 4 is a fragmentary cross-sectional view of the unit cell shown in FIG. 3;

FIG. 5 is an explanatory view of a seal member of the water electrolysis apparatus;

FIG. 6 is an explanatory view of another seal member of the water electrolysis apparatus;

FIG. 7 is a fragmentary cross-sectional view of a unit cell of a water electrolysis apparatus according to a second embodiment of the present invention; and

FIG. 8 is an explanatory view of a water electrolysis apparatus disclosed in Japanese Laid-Open Patent Publication No. 2004-002914.

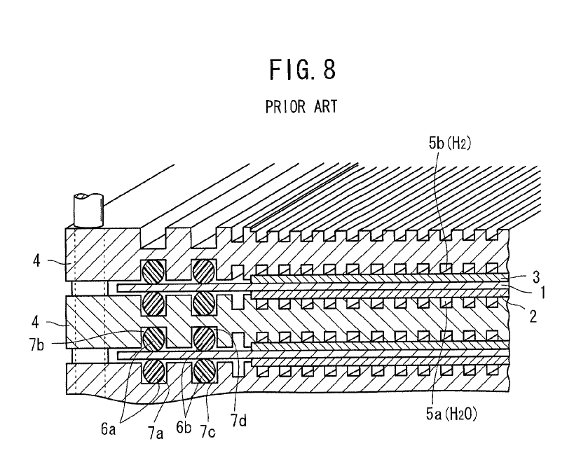

### DESCRIPTION OF THE PREFERRED EMBODIMENTS

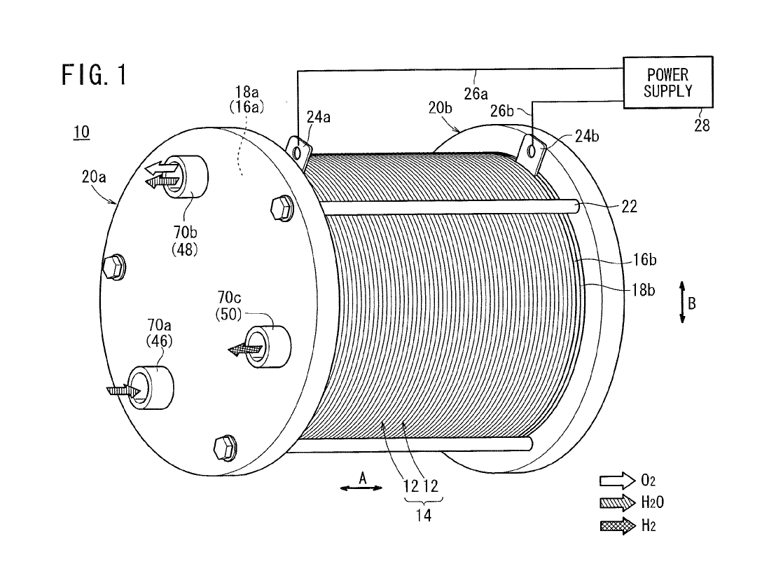

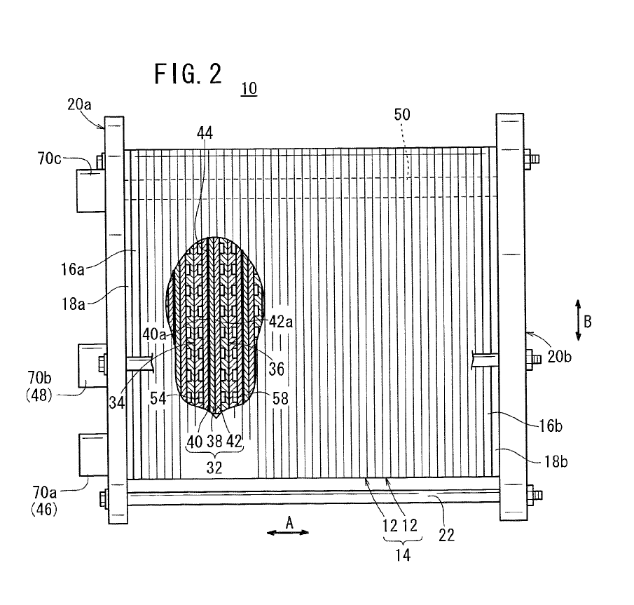

As shown in FIGS. 1 and 2, a water electrolysis apparatus 10 according to a first embodiment of the present invention serves as a high-pressure hydrogen manufacturing apparatus, and includes a stack assembly 14 comprising a plurality of unit cells 12 stacked in a horizontal direction indicated by the arrow A. The unit cells 12 may be stacked in a vertical direction indicated by the arrow B. The water electrolysis apparatus 10 also includes a terminal plate 16a, an insulating plate 18a, and an end plate 20a which are mounted on an end of the stack assembly 14 in the order named, and a terminal plate 16b, an insulating plate 18b, and an end plate 20b which are mounted on the other end of the stack assembly 14 in the order named. The unit cells 12, the terminal plates 16a, 16b, the insulating plates 18a, 18b, and the end plates 20a, 20b are of a disk shape.

The stack assembly 14, the terminal plates 16a, 16b, and the insulating plates 18a, 18b are fastened integrally together by the end plates 20a, 20b that are interconnected by a plurality of tie rods 22 extending in the directions indicated by the arrow A between the end plates 20a, 20b. Alternatively, the stack assembly 14, the terminal plates 16a, 16b, and the insulating plates 18a, 18b may be integrally held together in a box-like casing, not shown, which includes the end plates 20a, 20b as end walls. The water electrolysis apparatus 10 is illustrated as being of a substantially cylindrical shape. However, the electrolysis apparatus 10 may be of any of various other shapes such as a cubic shape.

As shown in FIG. 1, terminals 24a, 24b project radially outwardly from respective side edges of the terminal plates 16a, 16b. The terminals 24a, 24b are electrically connected to a power supply 28 by electric wires 26a, 26b, respectively. The terminal 24a, which is an anode terminal, is connected to the positive terminal of the power supply 28, and the terminal 24b, which is a cathode terminal, is connected to the negative terminal of the power supply 28.

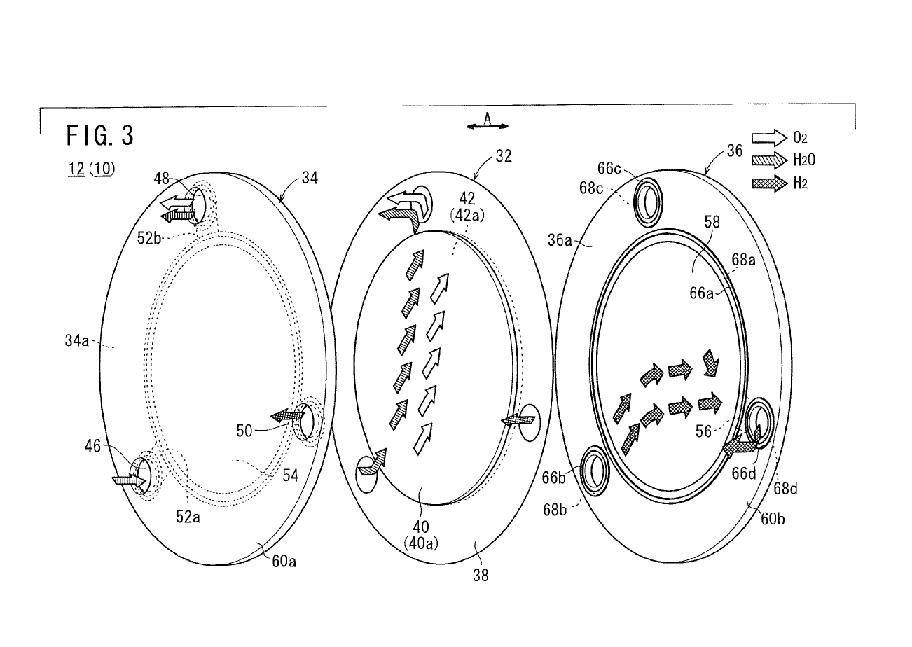

As shown in FIG. 3, each of the unit cells 12 comprises a disk-shaped membrane electrode assembly 32, and an anode separator 34 and a cathode separator 36 which sandwich the membrane electrode assembly 32 therebetween. Each of the anode separator 34 and the cathode separator 36 is of a disk shape and is in the form of a carbon plate, or in the form of a metal plate such as a steel plate, a stainless steel plate, a titanium plate, an aluminum plate, or a plated steel plate. Alternatively, each of the separators 34, 36 is formed by performing anti-corrosion treatment on the surface of such a metal plate and thereafter pressing the metal plate into shape, or by cutting the metal plate into shape and thereafter performing anti-corrosion treatment on the surface of the cut metal plate.

The membrane electrode assembly 32 has a solid polymer electrolyte membrane 38 comprising a thin membrane of perfluorosulfonic acid which is impregnated with water, and an anode current collector 40 and a cathode current collector 42 which are disposed respectively on the opposite surfaces of the solid polymer electrolyte membrane 38.

An anode catalyst layer 40a and a cathode catalyst layer 42a are formed on the opposite surfaces of the solid polymer electrolyte membrane 38, respectively. The anode catalyst layer 40a is made of a Ru (ruthenium)-based catalyst, for example, and the cathode catalyst layer 42a is made of a platinum catalyst, for example.

Each of the anode current collector 40 and the cathode current collector 42 is made of a sintered spherical atomized titanium powder (porous electrically conductive material), and has a smooth surface area which is etched after it is cut to shape. Each of the anode current collector 40 and the cathode current collector 42 has a porosity in the range of 10% through 50%, or more preferably in the range from 20% through 40%.

Each of the unit cells 12 has, in an outer circumferential edge portion thereof, a water supply passage 46 for supplying water (pure water), a discharge passage 48 for discharging oxygen generated by a reaction in the unit cells 12 and used water, and a hydrogen passage 50 for passing therethrough hydrogen (having pressure higher than ordinary pressure) generated by the reaction. The water supply passages 46 defined in the respective unit cells 12 communicate with each other in the stacking directions indicated by the arrow A. The discharge passages 48 defined in the respective unit cells 12 communicate with each other in the stacking directions indicated by the arrow A. The hydrogen passages 50 defined in the respective unit cells 12 communicate with each other in the stacking directions indicated by the arrow A.

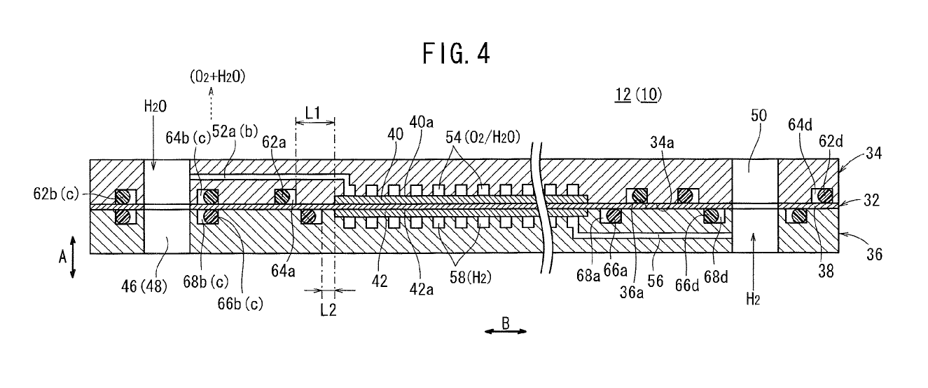

As shown in FIGS. 3 and 4, the anode separator 34 has a supply channel 52a defined in an outer circumferential edge portion thereof in fluid communication with the water supply passage 46 and a discharge channel 52b defined in an outer circumferential edge portion thereof in fluid communication with the discharge passage 48. The anode separator 34 also has a first flow field 54 defined in a surface 34a thereof which faces the membrane electrode assembly 32 and held in fluid communication with the supply channel 52a and the discharge channel 52b. The first flow field 54 extends within a range corresponding to the surface area of the anode current collector 40, and comprises a plurality of fluid passage grooves, a plurality of embossed ridges, or the like (see FIGS. 2 and 4).

The cathode separator 36 has a discharge channel 56 defined in an outer circumferential edge portion thereof in fluid communication with the hydrogen passage 50. The cathode separator 36 also has a second flow field 58 defined in a surface 36a thereof that faces the membrane electrode assembly 32 and held in fluid communication with the discharge channel 56. The second flow field 58 extends within a range corresponding to the surface area of the cathode current collector 42, and comprises a plurality of flow field grooves, a plurality of embossed ridges, or the like (see FIGS. 2 and 4).

Seal members 60a, 60b are integrally combined with respective outer circumferential edge portions of the anode separator 34 and the cathode separator 36. The seal members 60a, 60b are made of a seal material, a cushion material, or a gasket material such as EPDM, NBR, fluororubber, silicone rubber, fluorosilicone rubber, butyl rubber, natural rubber, styrene rubber, chloroprene, acrylic rubber, or the like.

As shown in FIG. 4, the surface 34a of the anode separator 34 which faces the membrane electrode assembly 32 has a first seal groove (first seal section) 64a defined therein which extends annularly around the first flow field 54 and the anode current collector 40. A first seal member 62a is disposed in the first seal groove 64a. The surface 34a of the anode separator 34 also has first seal grooves (first seal sections) 64b, 64c, 64d defined therein which extend annularly around the water supply passage 46, the discharge passage 48 and the hydrogen passage 50, respectively. First seal members 62b, 62c, 62d are disposed in the first seal grooves 64b, 64c, 64d, respectively. The first seal members 62a through 62d are, for example, o-rings.

The surface 36a of the cathode separator 36 which faces the membrane electrode assembly 32 has a second seal groove (second seal section) 68a defined therein which extends annularly around the second flow field 58 and the cathode current collector 42. A second seal member 66a is disposed in the second seal groove 68a.

As shown in FIGS. 3 and 4, the surface 36a of the cathode separator 36 also has second seal grooves (second seal sections) 68b, 68c and 68d defined therein which extend annularly around the water supply passage 46, the discharge passage 48 and the hydrogen passage 50, respectively. Second seal members 66b, 66c and 66d, each in the form of an O-ring, for example, are disposed respectively in the second seal grooves 68b, 68c and 68d.

The first seal groove 64a extending annularly around the anode current collector 40 and the second seal groove 68a extending annularly around the cathode current collector 42 are located across the solid polymer electrolyte membrane 38 from each other, respectively at different positions with respect to the stacking direction of separators indicated by the arrow A.

More specifically, in a planar direction of the solid polymer electrolyte membrane 38 indicated by the arrow B, a length L1 between the first seal groove 64a and the first flow field 54 into which ordinary-pressure water is supplied, is longer than a length L2 between the second seal groove 68a and the second flow field 58 in which high-pressure hydrogen is generated.

More preferably, the first seal groove 64a faces a flat surface of the cathode separator 36 across the solid polymer electrolyte membrane 38. The second seal groove 68a faces a flat surface of the anode separator 34 across the solid polymer electrolyte membrane 38. An inner edge portion of the first seal groove 64a is spaced radially outward from an outer edge portion of the second seal groove 68a.

The first seal groove 64d extending annularly around the hydrogen passage 50 and the second seal groove 68d extending annularly around the hydrogen passage 50 are located across the solid polymer electrolyte membrane 38 from each other, respectively at different positions with respect to the stacking direction of separators indicated by the arrow A (at staggered positions).

The first seal groove 64d faces a flat surface of the cathode separator 36 across the solid polymer electrolyte membrane 38. The second seal groove 68d faces a flat surface of the anode separator 34 across the solid polymer electrolyte membrane 38. An inner edge portion of the first seal groove 64d is spaced radially outward from an outer edge portion of the second seal groove 68d. Alternatively, the diameter of the second seal groove 68d may be set to be larger than that of the first seal groove 64d, and then the inner edge portion of the second seal groove 68d may be spaced radially outward from an outer edge portion of the first seal groove 64d.

As shown in FIGS. 1 and 2, pipes 70a, 70b, 70c are connected to the end plate 20a in fluid communication with the water supply passage 46, the discharge passage 48, and the hydrogen passage 50, respectively. A back pressure valve or a solenoid-operated valve, not shown, is connected to the pipe 70c for maintaining the pressure of hydrogen generated in the hydrogen passages 50 at a high pressure level.

Operation of the water electrolysis apparatus 10 will be described below.

As shown in FIG. 1, water is supplied from the pipe 70a to the water supply passage 46 in the water electrolysis apparatus 10, and a voltage is applied between the terminals 24a, 24b of the terminal plates 16a, 16b by the power supply 28. As shown in FIGS. 2 through 4, in each of the unit cells 12, the water is supplied from the water supply passage 46 into the first flow field 54 of the anode separator 34 and moves along the anode current collector 40.

The water is electrolyzed by the anode catalyst layer 40a, generating hydrogen ions, electrons, and oxygen. The hydrogen ions generated by the anodic reaction move through the solid polymer electrolyte membrane 38 to the cathode catalyst layer 42a where they combine with the electrons to produce hydrogen.

The produced hydrogen flows along the second flow field 58 that is defined between the cathode separator 36 and the cathode current collector 42. The hydrogen is kept under a pressure higher than the pressure in the water supply passage 46, and flows through the hydrogen passage 50. Thus, the hydrogen is extracted from the water electrolysis apparatus 10. The oxygen generated by the anodic reaction and the water that has been used flow in the first flow field 54 and then flow through the discharge passage 48 for being discharged from the water electrolysis apparatus 10.

According to the first embodiment, as shown in FIG. 4, the first seal groove 64a extending annularly around the anode current collector 40 and the second seal groove 68a extending annularly around the cathode current collector 42 are located across the solid polymer electrolyte membrane 38 from each other, respectively at different positions with respect to the stacking direction indicated by the arrow A.

More specifically, the first seal groove 64a faces the flat surface of the cathode separator 36 across the solid polymer electrolyte membrane 38. The second seal groove 68a faces the flat surface of the anode separator 34 across the solid polymer electrolyte membrane 38. Further, the second seal groove 68a is positioned radially inward with respect to the first seal groove 64a. Thus, the first seal member 62a disposed in the first seal groove 64a faces the flat surface of the separator so as to hold the solid polymer electrolyte membrane 38 between the first seal member 62a and the flat surface, while the second seal member 66a disposed in the second seal groove 68a faces the flat surface of the separator so as to hold the solid polymer electrolyte membrane 38 between the second seal member 66a and the flat surface.

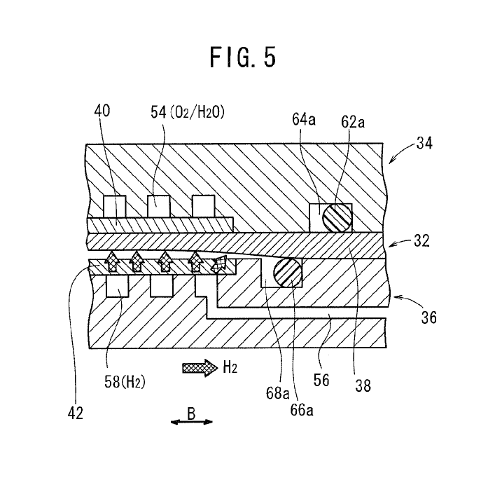

In the second flow field 58, high-pressure hydrogen is generated. Accordingly, the second flow field 58 serves as a high-pressure hydrogen generating chamber. On the other hand, ordinary-pressure water is supplied into the first flow field 54. As a result, a large pressure difference is caused between the first flow field 54 and the second flow field 58. Thus, as shown in FIG. 5, the solid polymer electrolyte membrane 38 deforms toward the anode current collector 40 by the high-pressure hydrogen through the second flow field 58 and the cathode current collector 42.

At that time, the second seal groove 68a faces the flat surface of the anode separator 34. Thus, the solid polymer electrolyte membrane 38 can be prevented from being damaged by, for example, the edge portion of the first seal groove 64a, as far as possible.

Further, since the first seal member 62a and the second seal member 66a face respectively the flat surfaces of the separators, the solid polymer electrolyte membrane 38 can be held flatly with certainty, compared with a structure in which the first seal member 62a and the second seal member 66a face each other across the solid polymer electrolyte membrane 38.

The holding performance of the solid polymer electrolyte membrane 38 is improved, and thus the solid polymer electrolyte membrane 38 can be prevented from being damaged as far as possible.

Also, according to the first embodiment, as shown in FIG. 4, the first seal groove 64d and the second seal groove 68d which extend annularly around the hydrogen passage 50 through which high-pressure hydrogen flows, are located across the solid polymer electrolyte membrane 38 from each other, respectively at different positions with respect to the stacking direction indicated by the arrow A.

Thus, the first seal member 62d in the first seal groove 64d faces the flat surface of the cathode separator 36 across the solid polymer electrolyte membrane 38, while the second seal member 66d in the second seal groove 68d faces the flat surface of the anode separator 34 across the solid polymer electrolyte membrane 38. Accordingly, the solid polymer electrolyte membrane 38 is held flatwise with certainty between the first and second seal members 62d, 66d and the flat surfaces of the separators.

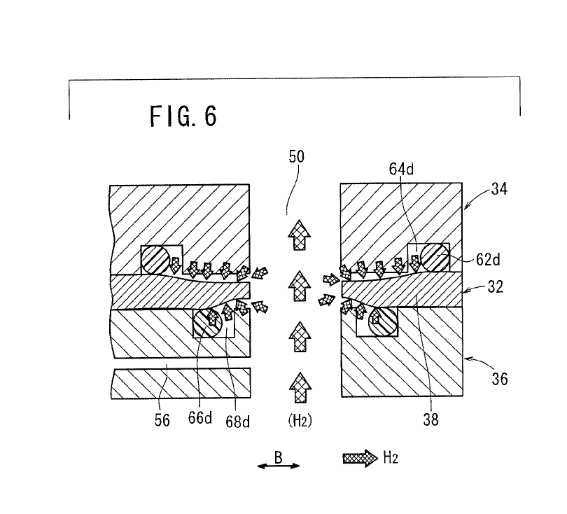

Further, as shown in FIG. 6, the hydrogen passage 50 serves as a high-pressure hydrogen chamber, and high-pressure hydrogen flows from the hydrogen passages 50 on both surfaces of the solid polymer electrolyte membrane 38. Accordingly, the first seal groove 64d and the second seal groove 68d each serve as a high-pressure hydrogen chamber.

Thus, the both surfaces of the solid polymer electrolyte membrane 38 are pressed under the same pressure in a region between the outer circumference of the hydrogen passages 50 and the second seal groove 68d. Consequently, the solid polymer electrolyte membrane 38 is prevented from being damaged by pressing by the inner edge portion of the second seal groove 68d.

On the other hand, the first seal groove 64d is filled with high-pressure hydrogen, and thus the solid polymer electrolyte membrane 38 is pressed toward the cathode separator 36. The first seal groove 64d faces the flat surface of the cathode separator 36 across the solid polymer electrolyte membrane 38. Consequently, the solid polymer electrolyte membrane 38 can be prevented from being damaged as far as possible.

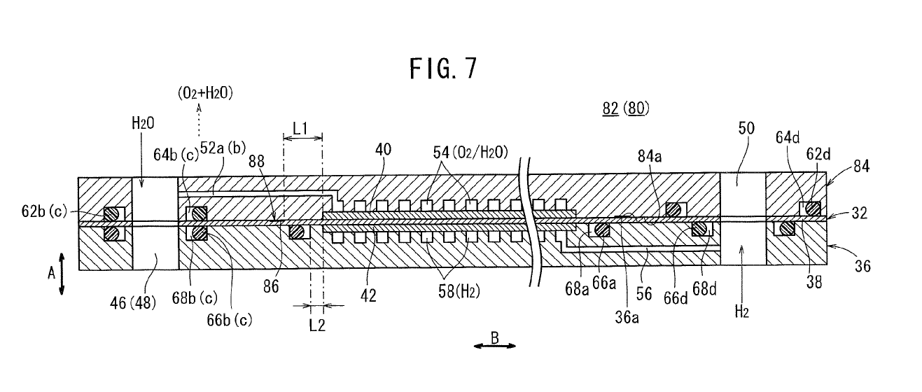

FIG. 7 is a fragmentary cross-sectional view of a unit cell 82 of a water electrolysis apparatus 80 according to a second embodiment of the present invention. Those parts of the unit cell 82 which are identical to those of the unit cell 12 of the water electrolysis apparatus 10 according to the first embodiment are denoted by identical reference characters and will not be described below.

Each of the unit cells 82 comprises a disk-shaped membrane electrode assembly 32, and an anode separator 84 and a cathode separator 36 which sandwich the membrane electrode assembly 32 therebetween. The surface 84a of the anode separator 84 which faces the membrane electrode assembly 32 has a first seal section 88 which extends annularly around the first flow field 54 and the anode current collector 40. A first seal member 86 is disposed in the first seal section 88.

The first seal member 86 is planate, and is disposed directly between the anode separator 84 and the solid polymer electrolyte membrane 38 to form the first seal section 88. The first seal member 86 may comprise a planar gasket, a rubber applied onto the anode separator 84, or a ring-shaped seal layer made of resin.

In a planar direction of the solid polymer electrolyte membrane 38 indicated by the arrow B, a length L1 between the first seal section 88 and the first flow field 54 is longer than a length L2 between the second seal groove 68a and the second flow field 58 in which high-pressure hydrogen is generated.

According to the second embodiment, the effects similar to those of the first embodiment are obtained. In particular, a structure thereof is simplified, and thus the water electrolysis apparatus can be manufactured more easily and more economically.

Although certain preferred embodiments of the present invention have been shown and described in detail, it should be understood that various changes and modifications may be made therein without departing from the scope of the appended claims.

What is claimed is:

1. A water electrolysis apparatus comprising:
an electrolyte membrane;
a pair of current collectors disposed respectively on opposite sides of the electrolyte membrane; and
a pair of separators stacked respectively on the current collectors, a circumferential edge portion of the electrolyte membrane being sandwiched between the separators;
wherein one of the separators has a first seal section extending annularly around one of the current collectors, a first seal member being disposed in the first seal section,
the other of the separators has a second seal section extending annularly around the other of the current collectors, a second seal member being disposed in the second seal section, and
the first seal section and the second seal section are located across the electrolyte membrane from each other, respectively at different positions with respect to a stacking direction of the separators.

2. The water electrolysis apparatus according to claim 1, wherein the first seal section comprises a seal groove for accommodating therein the first seal member, and
the second seal section comprises a seal groove for accommodating therein the second seal member.

3. The water electrolysis apparatus according to claim 1, wherein the first seal member comprises a planar seal member, and the first seal section is formed by disposing the planar seal member directly between the one of the separators and the electrolyte membrane, and
the second seal section comprises a seal groove for accommodating therein the second seal member.

4. The water electrolysis apparatus according to claim 1, wherein the one of the separators has a first flow field for supplying water,
the other of the separators has a second flow field in which hydrogen having pressure higher than normal pressure is produced through electrolysis of the water, the second flow field facing the first flow field across the electrolyte membrane,
the first seal section faces a flat surface of the other of the separators across the electrolyte membrane, and
the second seal section faces a flat surface of the one of the separators across the electrolyte membrane, and is spaced inwardly from the first seal section.

5. A water electrolysis apparatus comprising:
an electrolyte membrane;
a pair of current collectors disposed respectively on opposite sides of the electrolyte membrane;
a pair of separators stacked respectively on the current collectors, a circumferential edge portion of the electrolyte membrane being sandwiched between the separators; and
a hydrogen passage through which hydrogen produced through electrolysis of water flows in a stacking direction of the separators, the hydrogen passage extending through the electrolyte membrane and the pair of the separators,
wherein one of the separators has a first seal section extending annularly around the hydrogen passage, a first seal member being disposed in the first seal section,
the other of the separators has a second seal section extending annularly around the hydrogen passage, a second seal member being disposed in the second seal section, and
the first seal section and the second seal section are located across the electrolyte membrane from each other, respectively at different positions with respect to the stacking direction of the separators.

6. The water electrolysis apparatus according to claim 5, wherein the first seal section comprises a seal groove for accommodating therein the first seal member, and
the second seal section comprises a seal groove for accommodating therein the second seal member.

7. The water electrolysis apparatus according to claim 5, wherein the one of the separators has a first flow field for supplying water,
the other of the separators has a second flow field in which hydrogen having pressure higher than normal pressure is produced through electrolysis of the water, the second flow field facing the first flow field across the electrolyte membrane, and
the hydrogen passage communicates with the second flow field.
